(19) United States
(12) Patent Application Publication
(10) Pub. No.: US 2001/0045779 A1
(43) Pub. Date: Nov. 29, 2001

(54) Intelligent power system

(76) Inventors: Huey Lee, Fremont, CA (US); Ronald C. M. Sin, Fremont, CA (US); John Kua, San Jose, CA (US); Jimmy Chen Zhou, Fremont, CA (US)

Correspondence Address: Mr. C.P. Chang, Pacific Law Group LLP, Suite 290, Two North Second Street, San Jose, CA, 95113, US

(21) Appl. No.: 09/851,781

(22) Filed: May 8, 2001

Related U.S. Application Data
(60) Provisional application No. 60/207,738, filed on May 26, 2000.

(51) Int. Cl. H02J 9/00

(52) U.S. Cl. 307/66

(57) ABSTRACT

This invention provides a design for the uninterruptible power supply system to make it more compact in size, more intelligent in handling primary power source and other power source failure, more efficient and reliable. This 600 to 1000 watt power system is capable of taking AC, DC and battery power inputs and distributes to multiple loads after conversion. Its power sentry monitors and controls all power inputs and outputs, and capable of switching power inputs without affecting the outputs in case of power source failure. The power sentry also controls the speeds of the cooling fans, charges the batteries, communicates with the operator, displays status, manages power consumption, prepares the substitute power source before switching power source, and shuts down the whole system incase of emergencies.

### BACKGROUND OF THE INVENTION

1. Field of the Invention

The present invention relates generally to the field of “uninterruptible” power supplies. More particularly, the present invention relates to an uninterruptible power supply which includes a primary power source, a battery power source, an additional DC power source, a charger and battery system, peripherals and especially an apparatus to control all the power sources, outputs, charger system and peripherals that attached and utilizes the power of the said supply.

2. Related Background Art

Along with the booming of the Telecommunication and Internet industry, there is an ever-stronger need for uninterrupted power supply. Internet and cellular communication infrastructure demands a new generation of power source which is more compact in size, capable of delivering more power per cubic inch and be more intelligent, reliable and efficient. In addition, the power source needs to be smarter so that it can act as a power sentry, standing guard on not only the input power sources but also the outputs and its peripherals. It needs to be ready to switch, “glitchlessly” between different power sources and its backup battery, to activate audio and visual alarms and to execute critical commands and communicates with host computers and monitoring personnel. A compact system having all the features mentioned above is not seen other than the one that is to be present in the current invention.

The technology that most commonly seen is the traditional technology which utilizes standard power modules at 8 watts per cubic inch, and integrates these modules to make up a custom configured power supply with minimal or no intelligence. The advantage of this type of power supplies is that it is economical, and easily available. The disadvantage is that it is bulky in size and noisy and that it generates a lot of heat under high power and cannot perform efficient “glitchless” power switching for dual inputs, both DC and AC.

The more advanced technology that exists today, like the ones described in U.S. Pat. Nos. 5,872,984, 5,289,046 and 4,980,812, usually utilizes an array of batteries connected together to backup the primary AC power source. The backup batteries can provide sufficient power to the load for a short period of time. If the load served by the power supply requires DC as well as AC voltages, then the system may include one or more rectifiers to produce a DC voltage. At the output end, one or more power conversion stages are usually provided to convert the AC line voltage, the rectified line voltage, or the battery voltage to appropriate levels for the load. One disadvantage to this battery backup scheme is the necessity of a battery power conversion stage to transform the DC voltage from the battery to AC voltage in order to serve as a backup to the AC primary power source. With the advance of telecommunication technologies and Internet, systems are getting more and more complicated, this battery backup scheme along with the DC to AC conversion circuits may take up too much valuable space in the entire system. In addition, with the advance in technology, it is more desirable to create a portable system which is self-sustaining. Prior to 1990, designing a high wattage power supply may be impossible to achieve. However, with the advance in chip technology, such designs become feasible due to the availability of very efficient switching regulator ASIC chips and highly efficient magnetic cores. The present invention is a combination of these advanced technologies, along with the inventors' experience in designing compact, microelectronics and radio frequency technique to provide for a self-sustaining, compact, portable, high power system.

### SUMMARY OF THE INVENTION

The present invention relates to a power supply system having a compact high density power supply device, a battery device, a charger device, a Power Supply Management (“PSM”) device board with software and firmware, and peripherals like fans, status LEDs, to provide more intelligent, reliable and efficient power supply.

One aspect of the invention is to provide for a power supply system having at least a DC power source in addition to a primary AC power source and a desirable number of backup battery power sources.

Another aspect of the invention is to provide for a power supply system that has an input power switch, which feeds the AC inputs to an input filter. The primary AC input is being filtered for EMI and Common Mode noise prior to the AC-to-DC conversion. In addition, the input power switch is able to switch between power sources in case of failure of a particular power source then in use.

Another aspect of the invention is that the said power supply system has a AC-to-DC conversion stage which takes the AC input and converts it to DC power by utilizing high frequency switching technique and down converts the DC voltage into usable range.

Another aspect of the invention is to provide for a high frequency switching technique utilized in the AC to DC conversion stage. This technique uses a high flux density powder core and a special winding technique in the torroidal transformer that minimizes core loss and thus achieves size reduction and power density incrementation. The power supply system according to the invention can provide 600 to 1000 watt power.

Another aspect of the invention is to provide for a power supply system having a DC-to-DC converter design. The DC voltage output of the said AC-to-DC conversion stage is distributed to loads through several DC-to-DC converters. The DC-to-DC converter design uses dual mode regulator circuitry working out of phase of each other so as to minimize heat generation and, as a result, size reduction is achieved. Furthermore, the likelihood of cross talk is also minimized to reduce noise. If this technique works with a special grounding scheme, it will eliminate almost all of the noises generated by high current paths. The current could be as high as 60 amperes in some circuitry.

Another aspect of the invention is that the power supply system has a power sentry device, which has a programmable microprocessor. The power sentry microprocessor monitors and scans all aspects of the inputs of the said power sources, outputs of the said power supply system, heat sink temperature and internal temperature, speed and current of the fan, battery data such as charge and discharge cycle, battery temperature, state of charge or discharge, battery life history, charge and discharge current and voltages. The power sentry also displays data on the main and remote screen or a LCD panel, sounding an audible as well as a visual alarm for any function that is out of specification. The power sentry can communicate with the outside world in packet data via the serial or parallel ports and is able to co-ordinate with a main frame for power sharing as well as optional load sharing.

Another aspect of the invention is that the power supply system has an operating system, which is the brain of the entire system and is able to communicate with any operating system in a master control Main frame.

Another aspect of the invention is that the power supply system has a Lithium-Ion charger and battery system, which includes an array of Lithium-Ion batteries, a charger circuitry with a CPU processor, internal CACHE memory and SM Bus. The CPU processor of the charger circuitry controls and monitors the Lithium-Ion battery voltage, constantly comparing current data with data stored in memory, or communicating with CPU in the power sentry device. The communication between the charger and the battery is via SM bus and in serial packet data to transmit data and commands such as charge, discharge, disconnect, sleep and shutdown. The charger circuitry charges battery at a constant rate of 2 A (ampere). The charger CPU computes the charge cycle status and dispenses the charge current until the battery is ¾ charged, it then changes the charge rate to trickle charge from 200 mA (micro ampere) to 20 mA. A 5.5 ah battery at 32 volt will take approximately 4 hours to be fully charged.

### BRIEF DESCRIPTION OF THE DRAWINGS

FIG. 1 is a block diagram of the hardware design of the uninterruptible power supply system according to the invention; and

FIG. 2 is a detailed diagram illustrating the power supply management logic of FIG. 1.

### DETAILED DESCRIPTION OF AN PREFERRED EMBODIMENT

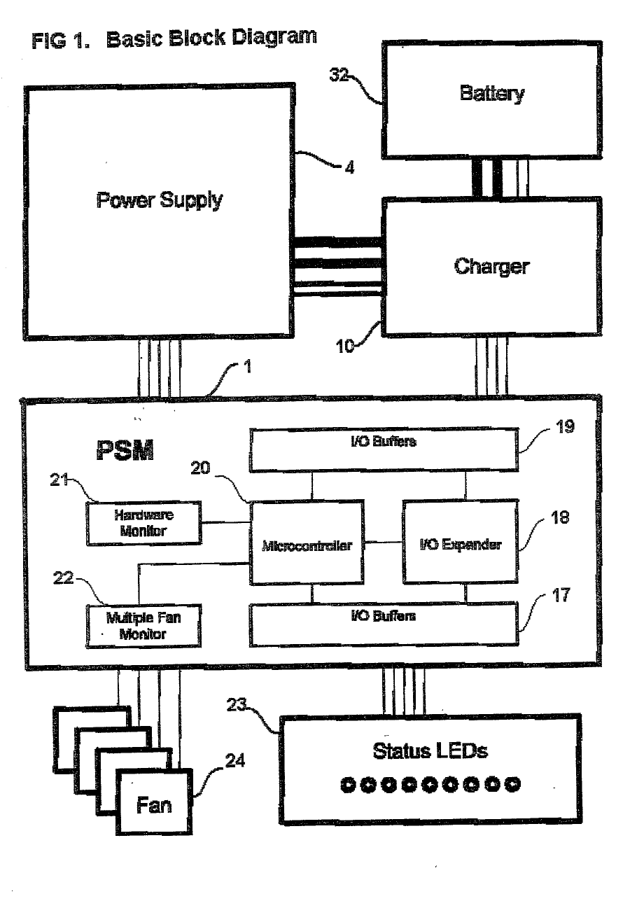

FIG. 1 shows the hardware design of the uninterruptible power supply system which operates to provide and maintain a continuous supply of power to desired loads. In FIG. 1, numeral 4 denotes a compact high density power supply, which has a power density of 20 Watt per cubic inch, while the standard existing power supply has a power density of only 8 Watt per cubic inch. This power supply runs at 85% efficiency at ambient temperature with power factor correction. Numeral 32 denotes a battery pack. Numeral 10 denotes a battery charger, which charges up to a 32.8V Li-Ion battery back 32 at 1.5 A, boosts circuit to allow for input voltages below pack charging voltage, and communicates with the battery pack 32 via SMBus for pack monitoring and gas gauging. Numeral 24 denotes the fans used by the system, which supports multiple fan monitoring lines with both current and tachometer monitors, and it's also configurable for fan availability and tachometer availability. Numeral 23 denotes Status LEDs, which are used for monitoring the operation of the system. Numeral 1 denotes the Power Supply Management (PSM) board with PSM software and firmware, which serves as a command and control center for the power supply 4, battery charger 10, fans 24, and hardware monitoring LEDs 23. Within PSM 1, numeral 21 denotes a hardware monitor, numeral 22 denotes a multiple fan monitor. Numeral 20 denotes a flash programmable microcontroller, which communicates with battery charger 10 and battery pack 32 and manages all the monitoring functions. The microcontroller 20 also transmits status information to the hardware monitor 21 and the multiple fan monitor 22 through a serial port or a parallel port using the glitchless switching technology provided by the invention. The glitchless switching technology employs technique which constantly stores information and status of the power supply in CACHE memory and a proprietary look ahead technology in anticipation of any change in the status of its functions, then when it is time to switch power source or power outputs, the power source or power outputs is already brought up to be readily engaged prior to switching. The microcontroller 20 allows for custom configuration of the board and future upgradability as well. Numeral 17 denotes an I/O buffer, numeral 19 denotes another I/O buffer, and numeral 18 denotes an I/O Expander.

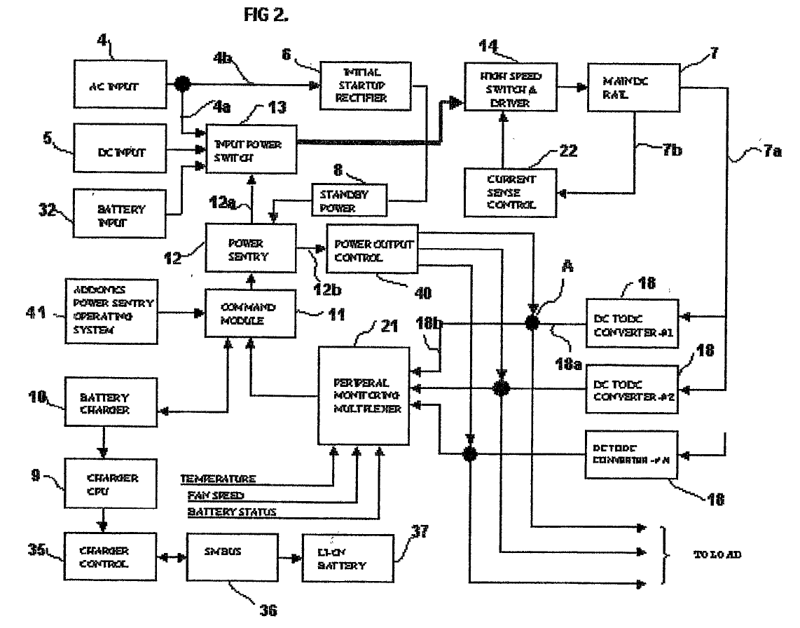

FIG. 2 shows the details of the intelligent power system according to the invention, especially the power supply management logic. Numeral 4 denotes a primary power source, which is an AC input, typically the local electric utility. Numeral 5 denotes a DC redundant power source, this power source will be supplying power to the system if the primary power source 5 is failing. Numeral 32 denotes the backup battery power source. The output of the DC power source 5, battery 32 and one output of AC primary power source 4, denoted by line 4a, are connected to an input power switch 13, which can select power supply from any one of the three input power sources. The other output of the AC primary power source 4, denoted by line 4b, is connected to an initial startup rectifier 6. The output of the initial startup rectifier 6 is connected to a standby power 8, which provides DC bias voltage for the circuitry. The output of the standby power 8 is connected to a power sentry 12, which constantly senses and stores status information of the AC power supply 4 extracted from the output of a command module 11. The power sentry 12 has two output lines, the one denoted by line 12a is connected to the input power switch 13. If the power sentry 12 senses a power failure in the AC primary power supply based on the status information it collected, it will issue a switch command to the input power switch 13 to switch the power input to the DC Input 5. Again, if the power sentry 12 senses a power failure in the DC power supply 5 as well, it will issue a switch command to the input power switch 13 to switch the power input to the battery input 32. The output of the input power switch 13 is connected to a high-speed switch and driver 14. The output of the high-speed switch and driver 14 is connected to a main DC rail 7. One output of the main DC rail 7, which is denoted by line 7b, is connected to a current sense control 22, and the output of the current sense control 22 is connected back to the high speed switch and driver 14. The other output of the main DC rail 7, which is denoted by line 7a, is connected in parallel to a group of DC to DC converters 18. The output of each of the DC to DC converter 18 is connected to one of a plurality of checkpoints A. Through line 18a, the checkpoints A are connected to loads, which are the power consumers like computers, TVs, . . . , etc. The checkpoints A are also connected to a peripheral monitoring multiplexer 21 through line 18b. The peripheral monitoring multiplexer 21 collects peripheral information such as temperature, fan speed and battery status. All the information that peripheral monitoring multiplexer 21 collected through the checkpoints A and peripherals is passed to the command module 11 though its connection to the later. Numeral 41 denotes a power sentry operating system, this operating system is able to communicate with any operating systems in the master control main frame. The power sentry operating system 41 hosts the command module 11, which is also connected to the power sentry 12. The power sentry operating system 20, the command module 11 and the power sentry 12 are all part of the microcontroller 20 in FIG. 1.

Referring to FIG. 2 again, the power sentry 12 is also connected to a power output control 40 through line 12b. the power output control 40 is connected to the plurality of checkpoints A. The power output control 40 scans all checkpoints A voltages at a predetermined sample rate and store these data in CACHE memory. The power sentry 12 monitors all aspects of the source input through its connection to the input power switch 13. In addition, the power sentry 12 also scans power supply output data collected by the power output control 40. The power sentry 12 also monitors heat sink temperature, internal temperature, fan speed and fan current data collected by the peripheral monitoring multiplexer 21. The power sentry 12 monitors battery data such as charge and discharge cycle, battery temperature, state of charge or discharge, battery life history, charge and discharge current and voltages through its connection to the battery charger 10. Furthermore, the power sentry 12 displays the normal data on the screen or the status LED panel 23 of FIG. 1, main and remote, and also give sound alarm and give visual alarm in the status LED 23 of FIG. 1. The battery charger 10 is connected to a charger CPU 9, and the charger CPU 9 is again connected to the charger control 35. Numeral 37 is a Li-Ion battery, and a SM Bus 36 that is actually also part of the Li-Ion battery package. The Li-Ion battery 37 communicates in serial packet data with the charger control 35 through the SM Bus 36. The battery charger 10, the charger CPU 9, the charger control 35, the SM Bus 36 and the Li-Ion battery 37 are all part of the charger 10 in FIG. 1. The Li-Ion battery 37 is potentially explosive, it is protected internally by a thermal fuse and current limiting shutout. Externally, the charger CPU 9 and the charger control 35 control and monitor the battery voltage data passed over by the SM Bus 36, and compare current data constantly with data stored in memory. The SM Bus can also carry commands such as charge, discharge, disconnect, sleep and shutdown from the charger control 35 to the Li-Ion battery 37. The battery charger 10 also passes the information such as the charge state to the command module 11. Since the command module 11 remembers the charge state, history of charge cycles and life of the battery, at a pre-determined number of cycles, the command module 11 will issue battery change warning thus signaling the need of battery replacement. The battery is charged at a constant rate of 2 A (ampere). The charger CPU 9 computes the charge cycle status and dispenses the charge current until the battery is ¾ charged, it then changes the charge rate to trickle charge from 200 μA (micro ampere) to 20 mA. The 5.5 ah battery at 32 volt will take approximately 4 hours to be fully charged. To prevent the potentially explosive Li-Ion battery from explosion, an extensive protection scheme is designed in the Li-Ion battery construction as well as its charging apparatus by employing a thermal fuse to endorse current limiting shutout, internally, while having the CPU processor in the charger circuitry to control and monitor battery voltage externally.

The power supply system according to the invention utilizes a combination of four layers of printed wiring boards. Each layer is protected by a thin layer of very thin laminate. Each laminate layer is impregnated with 4 to 5 oz copper traces made up of power supply circuitry. This layout scheme reduces internal dissipation and switching noises. In addition, the power supply system utilizes a maximum efficiency magnetic core materials with high frequency to achieve high-energy conversion without increasing internal dissipation.

In summary, the power supply system design according to the invention provides a switching scheme that utilizes a look ahead scheme in its pipe lining architecture as described above. The microprocessor in the power supply management board looks at the AC and DC input and output constantly. In case the microprocessor determines that there is a tendency for the AC power to fall below a specified level, it will prepare the DC power source to the ready-to-switch state. If the AC power source could not recover to above specified level within a pre-specified time, the switching scheme will switch the input power source to DC. In addition, if the DC power source again fails, the switching scheme will switch the input power source to Lithium Ion battery power source.

What is claimed is:

1. A compact, uninterruptible power supply system to provide and maintain a continuous supply of power to desired loads, comprising:
a high density power supply having a plurality of alternable power sources;
a battery charger to provide charges to at least one of the alternable power sources;
power source switching means to switch the power supply of the system among the plurality of alternable power sources; and
power supply management means to monitor the status of the plurality of alternable power sources based on a pre-determined power level so that the power source switching means is automatically activated to switch the power supply of the system from a first power source then in use to a second power source to ensure uninterruptable power supply when the first power source falls below the pre-determined power level.

2. The compact, uninterruptible power supply system according to claim 1 further comprises a plurality of status LEDs to monitor the operation of the system and a fan to cool the system.

3. The compact, uninterruptible power supply system according to claim 2 wherein the power supply management means is provided by a flash programmable microcontroller.

4. The compact, uninterruptible power supply system according to claim 3 wherein the microcontroller comprises a power sentry which constantly senses and stores status information of the alternable power sources.

5. The compact, uninterruptible power supply system according to claim 4 wherein the microcontroller further comprises a command module which provides status information of the AC power supply to the power sentry.

6. The compact, uninterruptible power supply system according to claim 5 wherein the microcontroller further comprises a sentry operating system to communicate with an external operation system.

7. The compact, uninterruptible power supply system according to claim 1 wherein the plurality of alternable power sources are selected from the group consisting of a DC power source, a battery and an AC primary power source.

8. The compact, uninterruptible power supply system according to claim 1 wherein the power source switching means is an input power switch.

9. The compact, uninterruptible power supply system according to claim 8 wherein the input power switch is connected to an output of the DC power source, the battery and an output of the AC primary power source to select power supply from any of the three input power sources.

10. The compact, uninterruptible power supply system according to claim 1 further comprises an initial startup rectifier connected to an output of the AC primary power source.

11. The compact, uninterruptible power supply system according to claim 10 further comprises a standby power connected to the initial startup rectifier to provide DC bias voltage to the system.

12. The compact, uninterruptible power supply system according to claim 4 wherein the power sentry is connected to the input power switch to monitor all aspects of the source input data through its connection to the input power switch

13. The compact, uninterruptible power supply system according to claim 12 wherein the power sentry issues a switch command to the input power switch to switch the power input to the DC Input if the power sentry senses a power failure in the AC primary power supply based on the status information collected.

14. The compact, uninterruptible power supply system according to claim 13 wherein the power sentry issues a switch command to the input power switch to switch the power input to the battery input if the power sentry senses a power failure in the DC power supply based on the status information collected.

15. The compact, uninterruptible power supply system according to claim 4 wherein the power sentry is further connected to a power output control to scan power supply output data collected by the power output control.

16. The compact, uninterruptible power supply system according to claim 15 wherein the power output control is further connected to a plurality of checkpoints through which the power is provided to the desirable loads.

17. The compact, uninterruptible power supply system according to claim 16 wherein the checkpoints are further connected to a peripheral monitoring multiplexer through which peripheral information such as heat sink temperature, internal temperature, fan speed and fan current data and battery status are collected.

18. The compact, uninterruptible power supply system according to claim 17 wherein the peripheral information collected thereof by the checkpoints is passed to the power sentry through the command module

19. The compact, uninterruptible power supply system according to claim 18 wherein the power output control scans all checkpoints voltages at a pre-determined sample rate and store these data in CACHE memory.

20. The compact, uninterruptible power supply system according to claim 4 wherein the power sentry displays the normal data and provides sound or visual alarm on the status LEDs.

21. The compact, uninterruptible power supply system according to claim 8 wherein the input power switch is connected to a high speed switch and driver to provide power switch.

22. The compact, uninterruptible power supply system according to claim 21 wherein the high speed switch and driver is further connected to a main DC rail that is connected in parallel to a group of DC to DC converters to provide power to the loads.

23. The compact, uninterruptible power supply system according to claim 1 wherein the battery charger further comprises a charger CPU, a charger control, a SM Bus and a Li-Ion battery.

24. The compact, uninterruptible power supply system according to claim 23 wherein the Li-Ion battery communicates in serial packet data with the charger control through the SM Bus for battery monitoring and gas gauging.

25. The compact, uninterruptible power supply system according to claim 24 wherein the SM Bus also carries commands such as charge, discharge, disconnect, sleep and shutdown from the charger control to the Li-Ion battery.

26. The compact, uninterruptible power supply system according to claim 23 wherein the battery charger can provide charges to the Li-Ion battery back up to a 32.8V at 1.5 A.

27. The compact, uninterruptible power supply system according to claim 23 wherein the battery charger is further connected to the power sentry to monitor battery data such as charge and discharge cycle, battery temperature, state of charge or discharge, battery life history, charge and discharge current and voltages.
